(19) United States
(12) Patent Application Publication
(10) Pub. No.: US 2018/0203703 A1
(43) Pub. Date: Jul. 19, 2018

(54) IMPLEMENTATION OF REGISTER RENAMING, CALL-RETURN PREDICTION AND PREFETCH

(71) Applicant: Optimum Semiconductor Technologies, Inc., Tarrytown, NY (US)

(72) Inventors: Mayan Moudgill, Chappaqua, NY (US); Gary Nacer, Morris Plains, NJ (US); A. Joseph Hoane, Yonkers, NY (US); Paul Hurtley, White Plains, NY (US); Murugappan Senthilvelan, Collegeville, PA (US)

(21) Appl. No.: 15/868,497

(22) Filed: Jan. 11, 2018

Related U.S. Application Data
(60) Provisional application No. 62/446,130, filed on Jan. 13, 2017.

(51) Int. Cl. G06F 9/38; G06F 9/30

(52) U.S. Cl. CPC G06F 9/3836; G06F 9/3867; G06F 9/3013

(57) ABSTRACT

A processor includes a plurality of physical registers and a processor core, communicatively coupled to the plurality of physical registers, the processor core to execute a process comprising a plurality of instructions to responsive to issuance of a call instruction for out-of-order execution, identify, based on a head pointer of the plurality of physical registers, a first physical register of the plurality of physical registers, store a return address in the first physical register, wherein the first physical register is associated with a first identifier, store, based on an out-of-order pointer of a call stack associated with the process, the first identifier in a first entry of the call stack, and increment, modulated by a length of the call stack, the out-of-order pointer of the call stack to point to a second entry of the call stack.

### RELATED APPLICATIONS

The present application claims priority to U.S. Provisional Application No. 62/446,130 filed on Jan. 13, 2017, the content of which is incorporated by reference herein.

### TECHNICAL FIELD

The present disclosure relates to processors and, more specifically, to systems and methods for managing renaming registers and a call stack associated with the processor.

### BACKGROUND

Processors (e.g., central processing units (CPUs)) may execute software applications including system software (e.g., the operating system) and user software applications. A software application being executed by a processor is referred to as a process to the operating system. The source code of the software application may be compiled into machine instructions. An instruction set (also referred to as an instruction set architecture (ISA)) specified with respect to a processor architecture may include commands that direct the processor operations.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a system-on-a-chip (SoC) including a processor according to an embodiment of the present disclosure.

FIG. 2 illustrates the usage of head pointer and tail pointer to a queue of physical registers used for register renaming

FIG. 3 illustrates an example of using a call stack to manage call instructions and return instructions of speculative instruction execution.

FIG. 4 illustrates a computing device according to an embodiment of the present disclosure.

FIG. 5 illustrates an implementation of a call stack and physical registers according to an embodiment of the present disclosure.

FIG. 6 is a block diagram illustrating a method for speculative executing call/return instructions according to an embodiment of the present disclosure.

### DETAILED DESCRIPTION

An instruction may reference registers for input and output parameters. For example, the instruction may include one or more operand fields for storing identifiers of the input and output registers. Registers may store data values, serving as sources of values for computation and/or as destinations for the results of the computation performed by the instruction. For example, the instruction addi $r3,$r5,1 may read the value stored in register r5, and increment the value by one (“1”), and store the incremented value in register r3. The instruction set architecture may define a set of registers (referred to as the architected registers) that may be referenced by instructions specified in the instruction set architecture.

Processors may be implemented according to the specification of instruction set architecture. Processors may include physical registers that can be used to support the architected registers defined in the instruction set architecture of the processor. In some implementation, each architected register is associated with a corresponding physical register. Using the following code sequence as an example,

div $r3,$r5,$r6

add $r4,$r3,1

mul $r3,$r5,$r6

where the processor first writes architected register r3 by executing the divide (div) instruction, then reads register r3 by executing the add instruction, and finally overwrites the register r3 by executing the multiply (mul) instruction. When each architected register is associated with a unique physical register, execution of the sequence of instructions by a processor implementing a pipelined architecture may cause a read-after-write hazard, i.e., overwriting r3 by a later instruction before a prior instruction completes. Thus, the implementation needs to ensure that the multiply instruction cannot complete (and write r3) before the add instruction is started (and read the value of r3 produced by the divide instruction).

High-performance processor implementations may use more physical registers than architected registers defined in the instruction architecture set. An architected register may be mapped to different physical registers over time. A list of physical registers that are currently not allocated (referred to as the free list) may provide the physical registers that are available for use. Every time a new value is written to the architected register, the value is stored to a new physical register, and the mapping between architected registers and physical registers is updated to reflect the newly created mapping. The update of the mapping is called register renaming Table 1 illustrates register renaming applied to the execution of the above sequence of instructions.

TABLE 1

| | | Mapping | | | | | | | | | |
|---|---|---|---|---|---|---|---|---|---|---|---|
| Architected | After Renaming | | r3 | r4 | r5 | r6 | | Free List | | | |
| | | . . . | | | R5 | R11 | . . . | R8 | R16 | R9 | . . . |
| div | div | | R8 | | R5 | R11 | | R16 | R9 | . . . | . . . |
| $r3, $r5, $r6 | $R8, $R5, $R11 | | | | | | | | | | |
| add $r4, $r3, 1 | add $R16, $R8, 1 | | R8 | R16 | R5 | R11 | | R9 | . . . | . . . | . . . |
| mul | mul | | R9 | R16 | R5 | R11 | | . . . | . . . | . . . | . . . |
| $r3, $r5, $r6 | $R9, $R5, $R11 | | | | | | | | | | |

In the example as shown in Table 1, architected registers are denoted with lower case (r#), and physical registers are denoted with upper case (R#). Architected register r3 is allocated to physical register R8 from the free list. The result of the divide instruction is written to R8. The add instruction reads from the physical register R8. The multiply instruction writes to a physical register R9 after register renaming. Consequently, the multiply instruction can be executed without the need to avoid overwriting the result of the divide instruction because the architected register r3 is mapped to different physical registers through register renaming

Register renaming may also determine registers that are no longer needed and can be returned to the free list. For instance, after the add instruction has read the value stored in R8, R8 is determined no longer needed and can be returned to the free list.

Register renaming is typically combined with out-of-order execution in a pipeline execution of instructions to achieve high performance. In such a case, the determination of whether to release a register back to the freelist may need to take into account the need to maintain the in-order state (i.e. preserving the ability to roll back the processor state to the original state at the beginning of an instruction execution under certain conditions including such as, for example, failed speculative execution of other instructions). For example, it is possible that R8 cannot be released until the multiply instruction is retired.

If there are no registers available in the free list, the processor may hold up issuing more instructions until some already issued instructions complete their execution, and release physical registers to the free list. At that point, the processor may resume issuing new instruction.

Architected registers can be classified into different types (e.g., floating point for storing floating point values, general-purpose integer for storing integer values etc.). In some implementations, each type of architected registers is associated with a single pool of corresponding physical registers for register renaming. For example, there may be a pool of floating point physical registers used to rename architected floating point registers and a pool of general purpose physical registers that is used to rename the architected general purpose registers.

In implementations where the total number of architected register of a certain type is small or where different architected registers exhibit different behaviors, each architected registers may be associated with a pool of physical registers. For example, if only two architected registers of a certain type t (e.g., $t0 and $t1) are defined in the instruction architecture set, eight physical registers may be divided into two pools, including a first pool of four physical registers dedicated to renaming $t0 and another four dedicated to renaming $t1. This approach is inefficient for larger sets of architected registers. For example, 16 general purpose registers that need to be renamed each at least 6 times, a total of 96 physical registers are needed to constitute the 16 pools.

If a single pool of physical registers is associated with an architected register, the pool can be implemented using a rotating buffer of physical registers—i.e. a queue. This implementation can include components of:
an array of physical registers including a number (N) of physical registers,
a head pointer (HD) that indexes into the array,
a tail pointer (TL) that also indexes into the array, and
a component for detecting whether the pool of physical registers are completely mapped to architected registers. To detect whether the pool of physical registers are completely mapped to the architected registers, the processor can:
   1. keep a counter of the number physical registers in use, or
   2. compare the positions of HD and TL.

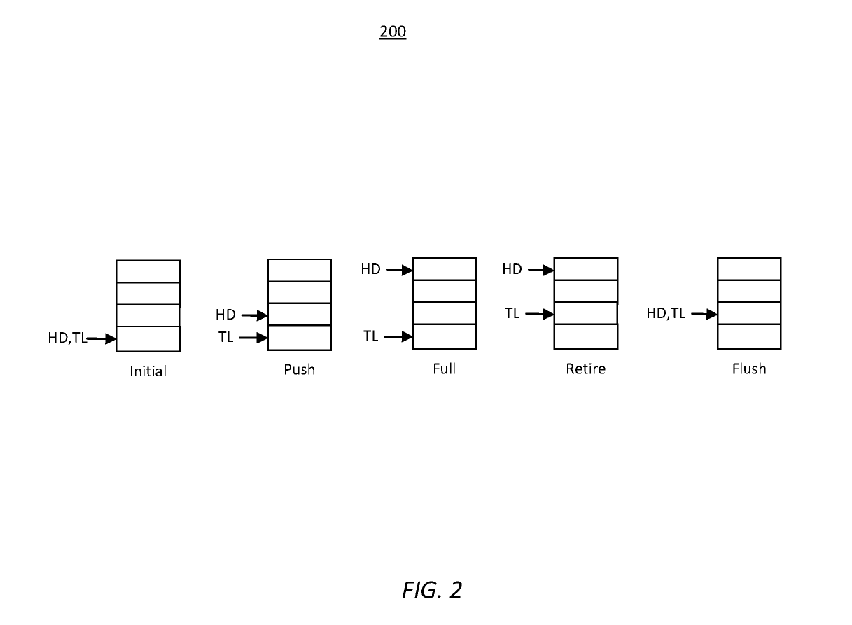

The head pointer and the tail pointer may be used as shown in FIG. 2, where renaming registers are implemented as a circular stack that can be accessed either last-in-first-out (LIFO) or first-in-first-out (FIFO). Compared with other implementations of renaming registers, the circular stack of renaming registers keeps track of free physical registers and occupied physical registers using two pointers (HL and TL). Thus, the circular stack is a simpler implementation of renaming registers that occupies a smaller circuit area and consumes less power. Assuming that the completely-mapped pool of physical registers is determined based on a comparison between the head pointer and the tail pointer, the processor can:
Initially, set both the head pointer and tail pointer pointing to the same value (e.g., 0);
When a new architected register is renamed by the processor executing a read instruction referencing the architected register, the processor may move the head pointer to point to the physical register from which the content is read;
When a new architected register is renamed by the processor executing a write instruction referencing the architected register, the processor may increment the head pointer modulo the total number (N) of physical registers, where the incremented head pointer points to the new physical register that is to be written to. Incrementing the head pointer may include include moving the head pointer to point to another physical register identified by a higher index value;
If the head pointer is one less than the tail pointer (modulo N), the processor may determine that the pool of physical registers are completely used up (or all having been mapped to architected registers), and may stop issuing instructions that invoke a write operation to the architected register;
When physical registers are freed in the Last In First Out (LIFO) order, the processor may increment the tail pointer (modulo N), thus resulting in freeing the previous position pointed to by the tail pointer. When physical registers are freed in the First In First Out (FIFO) order, the processor may decrement the head pointer (modulo N).
Responsive to a roll-back of the execution states of the processor due to an erroneous speculative (out-of-order) execution of instructions, the processor may map the architected register to the last physical register in the queue that is not freed by the roll-back. In some implementations, this may be equivalent to setting the head pointer to the value of the tail pointer.

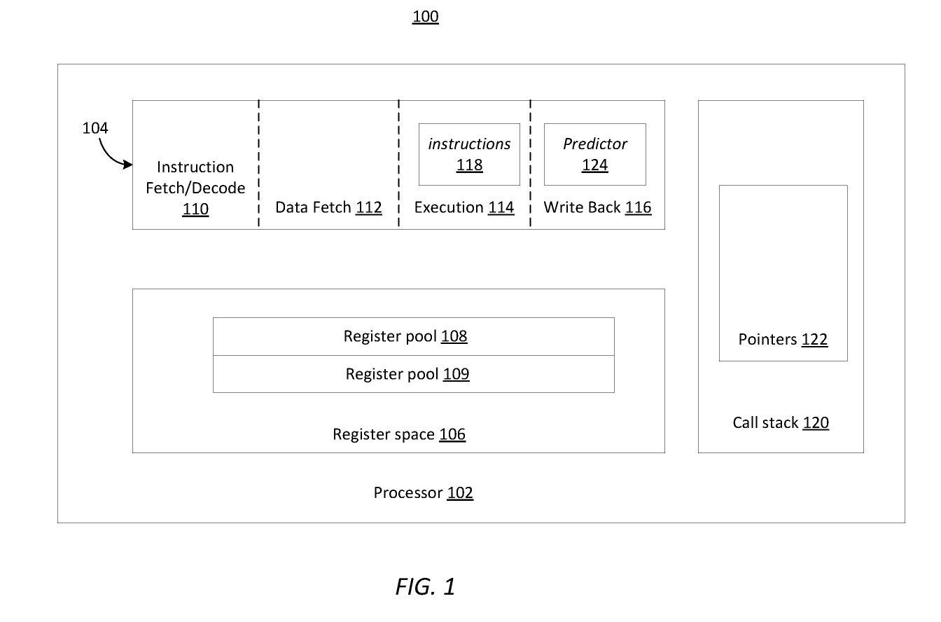

FIG. 1 illustrates a system-on-a-chip (SoC) 100 including a processor 102 according to an embodiment of the present disclosure. Processor 102 may include logic circuitry fabricated on a semiconductor chipset such as SoC 100. Processor 100 can be a central processing unit (CPU), a graphics processing unit (GPU), or a processing core of a multi-core processor. As shown in FIG. 1, processor 102 may include an instruction execution pipeline 104 and a register space 106. Pipeline 104 may include multiple pipeline stages, and each stage includes logic circuitry fabricated to perform operations of a specific stage in a multi-stage process needed to fully execute an instruction specified in an instruction set architecture (ISA) of processor 102. In one example implementation, pipeline 104 may include an instruction fetch/decode stage 110, a data fetch stage 112, an execution stage 114, and a write back stage 116.

Register space 106 is a logic circuit area including different types of physical registers associated with processor 102. In one embodiment, register space 106 may include register pools 108, 109 that each may include a certain number of physical registers. Each register in pools 108, 109 may include a number of bits (referred to as the “length” of the register) to store a data item processed by instructions executed in pipeline 104. For example, depending on implementations, registers in register pools 108, 109 can be 32-bit, 64-bit, 128-bit, 256-bit, or 512-bit.

The source code of a program may be compiled into a series of machine-executable instructions defined in an instruction set architecture (ISA) associated with processor 102. When processor 102 starts to execute the executable instructions, these machine-executable instructions may be placed on pipeline 104 to be executed sequentially (in order) or with branches (out of order). Instruction fetch/decode stage 110 may retrieve an instruction placed on pipeline 104 and identify an identifier associated with the instruction. The instruction identifier may associate the received instruction with one specified in the ISA of processor 102.

The instructions specified in the ISA may be designed to process data items stored in general purpose registers (GPRs). Data fetch stage 112 may retrieve data items (e.g., bytes or nibbles) to be processed from GPRs. Execution stage 114 may include logic circuitry to execute instructions specified in the ISA of processor 102.

In one implementation, the logic circuitry associated with execution stage 114 may include multiple “execution units” (or functional units), each being dedicated to perform certain set of instructions. The collection of all instructions performed by these execution units may constitute the instruction set associated with processor 102. After execution of an instruction to process data items retrieved by data fetch stage 112, write back stage 116 may output and store the results in physical registers in register pools 108, 109.

The ISA of processor 102 may define an instruction, and the execution stage 114 of processor 102 may include an execution unit 118 that includes hardware implementation of the instruction defined in the ISA. A program coded in a high-level programming language may include a call of a function. The execution of the function may include execution of a sequence of instructions. At the beginning of the execution of the function, the execution stage 114 of pipeline 104 may preserve a return address by saving the return address at a designated storage location (e.g., at a return register). The return address may point to a storage location that stores an instruction pointer. At the conclusion of the execution of the function, a return instruction may return to the instruction pointer saved as the return address. In one implementation, processor 102 may include a call stack 120 that is a stack data structure for storing pointers 122 to the return addresses of functions being executed. Call stack 120 may keep track of the location (e.g., through an address pointer) of the next instruction after a call—i.e. the address to be the target matching return for that call. Consider the sequence of calls as shown in Table 2:

TABLE 2

A: call
..
B: call
..
X: return (to B + 4)
..
C: call
..
Y: return (to C + 4)
...
Z: return (to A + 4)

In the sequence of calls in Table 2, the call stack 120 is used to keep track of the calls and returns (call pointer+4), where A, B, C are calls and X, Y, Z are returns. These pointers are pushed on to the call stack 120 on calls and popped after returns. When multiple pairs of calls/returns are executed in pipeline 104, it is very likely that the address of a return instruction branches to the top of the call stack 120. Table 3 shows the call stack for the calls as shown in Table 2, where it is assumed that the address is 32 bits.

TABLE 3

after call at A: [A + 4]
after call at B: [A + 4, B + 4]
after return at X: [A + 4]
after call at C: [A + 4, C + 4]
after return at Y: [A + 4]
after return at Z: [ ]

In some implementations, a call is carried out by a call instruction that branches to a new address while writing the return address to a register (e.g., [B+4] after carrying out call B). The corresponding return instruction reads from the register and branch to that address. These call and return instructions can be dedicated instructions, or can be variations on jump/branch instructions.

In some implementations, either because of the definition of the call/return instruction, or because of the software calling convention used, the register that stores the return address can be the same architected register for different calls. If there are two calls carried out in succession with no intervening return, the second call can overwrite the return register. So, there is a need to back up the return register, preserving the return address for later copying the value back to the return register.

In a high-performance implementation that issues instructions speculatively out of order, when a return instruction is issued, the pipeline 104 (e.g., write back circuit 116) may need to fetch instructions at the target of the return. Due to the sequence of calls are carried out speculatively, however, the return address may be unavailable. In that case, pipeline 104 may include a predictor circuit 124 to predict the next address based on the call stack. The predictor circuit 124 may be part of the write back circuit 116 that determines the target of the return. In one implementation, predictor circuit 124 may use the value at the head of the call-stack to predict the next return address.

At some later point of the execution, the predicted return address is compared against the actual return address. If these two return addresses are different, the return prediction is determined to be incorrect. The processor state is rolled back to the in-order state for the return instruction, and instruction fetch is resumed at the correct address.

When processor 102 is implemented with pipeline 104 allowing speculative execution of instructions, the call stack may include an in-order component (IO) and an out-of-order component (OoO). The in-order component (IO) keeps a record of all call/return instructions that have retired; the out-of-order component keeps a record of all call/return instructions that have been issued, including those issued speculatively.

Some implementations of the call stack may include the following components to support speculative execution of instructions:
An address array of a determined size (M, where M is an integer value), where the address array can be a memory region specified by a determined size of address space,
An in-order top-of-stack (IO ToS), and
An out-of-order top-of-stack (OoO ToS)

These components can be used as following:
When a call instruction is issued, the return address is added to the stack at the location pointed to by the current OoO ToS and the OoO ToS pointer is incremented modulo M (M is the length of the call stack).
When a return instruction is issued, the value stored at the OoO ToS is used as the predicted next address, and the OoO ToS pointer is decremented modulo M.
When a call (or return) instruction is retired, the IO ToS is correspondingly incremented (or decremented) modulo M.
If the processor state is rolled back for any reason, the OoO ToS is set to the IO ToS.

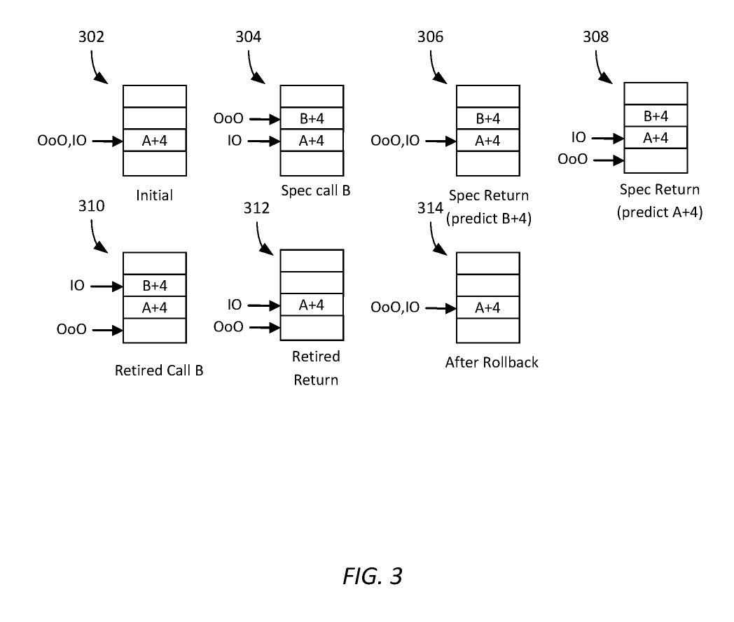

FIG. 3 illustrates an example of using a call stack to manage call/return of speculative instruction execution. As shown in FIG. 3, processor 102 may maintain a call stack. At 302, call stack may initially have both the IO pointer and OoO pointer point to a same entry of the call stack. The entry may store a return address of A+4. At 304, processor 102 may speculatively execute a second instruction (B) and increment the OoO pointer modulo M. The OoO pointer may point to an entry storing a predicted return address (B+4) for the second call (B). At 306, processor 102 may complete the second call (B) and set OoO pointer to the predicted return address (predicted B+4). At 308, processor 102 may speculatively complete the first call (A) and set OoO to the predicted return address (A+4). At 310, the processor may actually retire the second call (B) and set IO pointer to the return address of the second call (B). At 312, the processor may actually retire and return from the second call (B) and set IO pointer to the return address of the first call (A). Step 314 shows the effect of an exception after the state 312. Since the IO pointer and OoO pointer do not match, at 314, processor 102 may need to roll back to the current in-order, setting OoO ToS to the IO ToS, indicating that the return from A has not yet been retired.

In some implementations, there may be special logic circuit to detect the under-flow condition, where the number of successive returns exceeds the size of call stack (M). In that case, the processor may include logic that disables prediction, and waits for the actual return address to be fetched.

In some implementations, the return register—the register that is used for calls and returns—is fixed to a specific architected register. As part of renaming, this architected register is renamed to a new physical register every time it is written over. For example, every time a call instruction is executed, that return register is renamed and allocated with a new physical register. The value stored in the return register is the address of the instruction after executing the call instruction. Other reasons for return register renaming may include the return address register being written over by whatever means used to save and restore return address values during the function calling sequence.

When the register renaming is implemented using a queue as described above, the call stack may be implemented using a subset of the renaming entries (i.e., the physical registers in the renaming register pool) that have been written by the calls. Implementations of the present disclosure may provide systems and methods to implement the call stack using the register renaming entries. Compared to implementing the call stack and the renaming registers using separate index systems, implementations of the present disclosure reduce the circuit area and power consumption needed to manage the call and return instructions. For example, if the call stack and the renaming register pool are implemented separately, the entries of the call back may be 64-bit wide to store a full address. If the call stack is implemented to store a renaming register index, the entries of the call stack may require fewer bits. For example, an eight renaming register pool can be indexed using 3 bits, thus reducing the circuit area and power consumption of the processor.

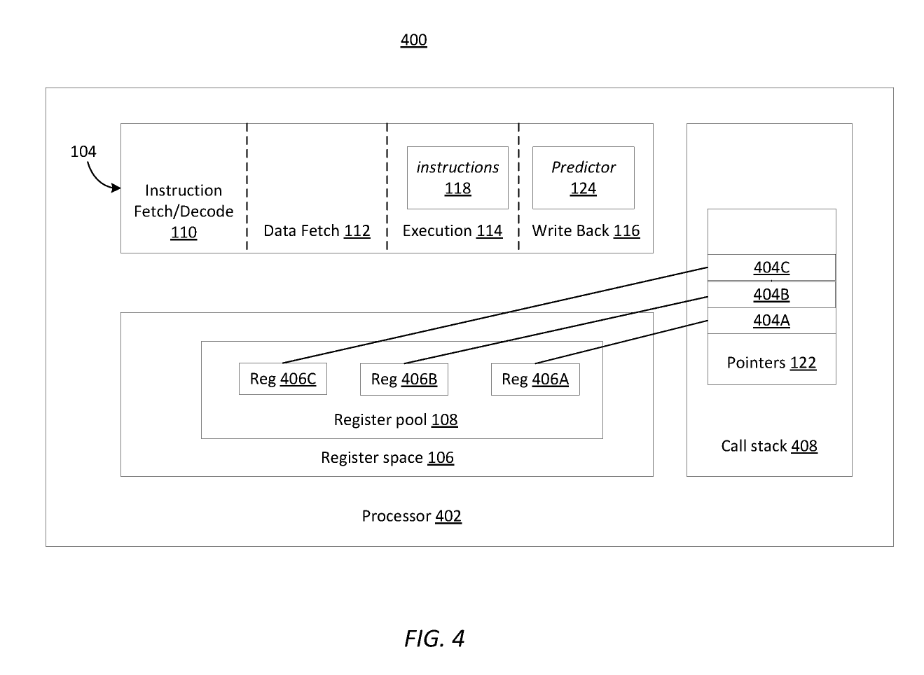

In one embodiment of the present disclosure, entries in the call stack are indexed into the array of renaming registers that store the return addresses rather than using a fixed architected register to store the return addresses. FIG. 4 illustrates a computing device 400 according to an embodiment of the present disclosure. As shown in FIG. 4, processor 402 may include a call stack 408 that include entries 404A-404C that are directly indexed into registers 406A-406C. For example, the registers in an eight register pool may be indexed using only three bits. Registers 406A-406C in register pool 108 are used as renaming registers. Thus, call stack 408 indexes directly with renaming registers 406A-406C. The following example may illustrate how this embodiment works. Consider the sequence of 2 calls including:

A: call X

B: call Y,

where the call instructions write to a return architected register $btr. The call stack for this sequence is:

B+4

A+4.

Assume that instruction address includes 8 bytes, meaning that 64-bit address for each entry. Further assume that the return architected register btr is renamed to $BTR0 for the first call (Call X) and $BTR2 for the second call (Call Y). The values stored in these two physical register are

$BTR2<-B+4

$BTR0<-A+4

The call stack can be implemented by storing, in the return register, the index number of the physical register that contains the return address. In this particular sequence, the call stack can be implemented by storing in

$BTR2

$BTR0

If there are 8 physical return registers, three bits per entry are needed to index in the call stack. To predict the return address from the return address from Call Y, the execution stage read the call stack and based on the reading, look in $BTR2, which is B+4.

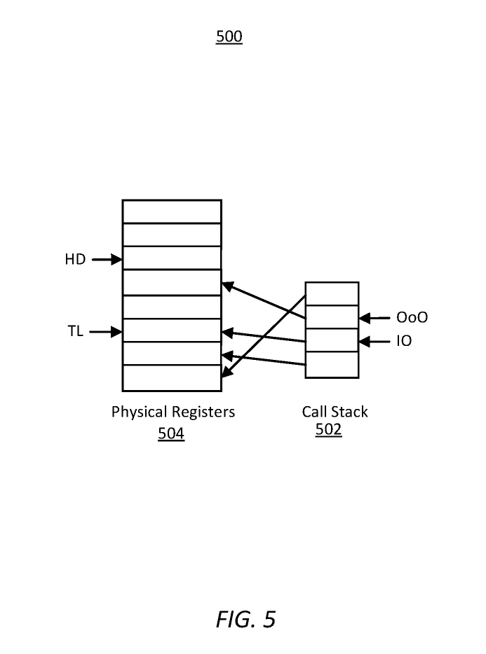

FIG. 5 illustrates an implementation 500 of a call stack 502 and physical registers 504 according to an embodiment of the present disclosure. Call stack 502 may be associated with an IO pointer and an OoO pointer as discussed above. Physical registers 504 may be implemented as a queue associated with a head pointer (HD) and a tail pointer (TL) as discussed above. Physical registers 504 are used to store return addresses. Call stack 502 and physical registers 504 may work collaborative as following:
A call instruction is issued to an instruction execution pipeline (e.g., pipeline 104) for out-of-order execution;
The instruction execution circuit (e.g., execution unit 114) may store a return address corresponding to the call instruction in a physical register pointed to by a head (HD) pointer of a queue of renaming physical registers, wherein the HD pointer is identified by an index value;
The instruction execution circuit may then store the index value of the HD pointer indicating the current return address register in the entry of the call stack pointed to by the OoO pointer of the call stack and cause to increment the OoO pointer modulo length of the call stack (M). Incrementing modulo M (an integer) means that HD=(HD+1)% M. For example, if M is eight (8) and HD is seven (7), the new value of HD is zero (0);
When a return instruction associated with the call instruction is issued for the out-of-order execution, the instruction execution circuit may first determine the index value stored in the entry pointed to by the OoO pointer and determine the return address register in the queue of renaming physical registers. The return address register pointed to by the OoO may contain the predicted next instruction address. The OoO pointer is decremented modulo M;
When a call (or return) instruction is retired, the IO is incremented (or decremented) modulo M.
If the processor state is rolled back for any reason, the OoO pointer is set to the IO pointer.

This implementation of the disclosure is more efficient than a traditional call-stack implementation in terms of circuit area usage, since the entries are indexed into a small number of physical registers (that needs 2-4 bits to address), rather than a full memory address (32 or 64 bits).

It should be noted that this technique can be used in combination with a standard pool based register renaming as well, with the call stack pointing to entries in the pool. To avoid the risk of having the return values being freed and reallocated while still being pointed to from the call stack, the allocation mechanism may be be modified so that physical registers being pointed to by the call stack are reallocated as infrequently as possible. Namely, if there are registers in the free list, where some of which are pointed to from the call stack and some which are not, the processor may include a register allocator circuit that picks from those registers that are not pointed to by the call stack. Responsive to determining that all free registers are pointed to by the call stack, the register allocator circuit reallocates a register pointed to by the call-stack. Among those registers, the register allocator circuit selects the register pointed to using the entry deepest in the call stack. In that case, the register allocator circuit may also mark entry invalid by setting a validity flag associated with the entry.

In another embodiment of the present disclosure, each one of physical registers 504 may include two flags (e.g., using two flag bits). The first flag bit may indicate whether the physical register has been written because of a call or not, and the second flag bit may indicate whether the physical register has already been used for a call stack prediction. The IO pointer and OoO pointer may directly index into these physical registers 504 without the need for call stack 502. In this embodiment, the predictor 124 is responsible for OoO pointer, and the register rename unit is responsible for the head (HD) pointer. Additionally the tail (TL) pointer will be advanced as part of the normal renaming process.
When a call instruction is issued,
   the processor may allocate a new physical register for the architected return register from the pool (108), and may store a return address in the allocated physical register. The processor may further increment, the head pointer position, modulo register pool size to point to a next return register;
   the processor may set a first flag bit associated with the physical register to a first value (e.g., “1”) to indicate that the physical register is written by a call instruction, and set a second flag bit associated with the physical register to a second value (e.g., “0”) to indicate that the physical is marked as not having been used for return address prediction;
the OoO pointer is set as equal to this HD pointer.
When another instruction that writes to the architected return register is issued,
   a new physical register is allocated for the architected return register from the pool (108) to store a new return address, resulting in the HD pointer being incremented modulo register pool size;
   this new physical register is marked as not being written by a call instruction
   the OoO pointer is left unmodified.
When a return instruction is issued,
   the value in the physical register in the return register pool pointed by the OoO pointer is used as the predicted next address,
   the physical register is marked as having been used as a prediction;
   The OoO pointer is decremented one or more times modulo the register pool size till the OoO pointer is moved to point to a physical register that is marked as having been written by a call instruction (e.g., the first flag bit is set) and is marked as not having been used for a prediction (e.g., the second flag bit is not set).
When a call/return instruction is retired, the IO pointer is incremented/decremented one or more times modulo the register pool size till it points to a physical register that is marked as having being written by a call. Additionally the tail (TL) pointer will be advanced as part of the normal renaming process. When the return instruction retires, the IO pointer may correspondingly decrement to a physical register marked as written by a call instruction.
If the processor state is rolled back for any reason, the HD pointer is set to the TL pointer as part of the normal renaming process. In addition
   the OoO pointer is set to the IO pointer.
   All physical register entries are marked as not being used for a prediction.

Thus, the increment (or decrement) of IO pointer and OoO pointer may need to search for the next (or previous) entry that has been written by a call, and potentially have not been used for a prediction.

Embodiments of the present disclosure may provide a processor including a branch target predictor circuit that predicts the target of a taken conditional branch or unconditional branch instruction before the target of the branch instruction is computed. The predicted branch targets may be stored in branch target registers associated with the processor. Typically, there are branch target registers and a target return register. Branch target registers provide branch addresses to indirect branch instructions other than the return instruction. The target return register provides the branch address to the return instruction, and is written by the call instruction with the call return address value (e.g. address of call instruction+4). Further, embodiments of the present disclosure provide for one or more target base registers that are used for storing the intermediate base addresses. An address can be calculated from the base address plus a displacement. The target base register does not provide values to a branch instruction or return instruction.

When the number of architected registers is small, the branch target registers and the target return register may be implemented as a per-register queue as described above. The size of the physical register pool can be different for each branch target register. In particular, since the return target register is being used as part of the call-stack mechanism, it makes sense for the return register pool to have considerably more physical registers than the other registers. The larger return register pool can allow a larger call stack.

In some implementations, the branch target register values act as instruction prefetch hints. The per-register queue implementation provides information that allows for fine tuning of the selection between the addresses as following:
For branch target registers, the physical register at the head of the queue is used as the hint for predicting future branch instructions unless there is a roll-back. If there is a roll-back, the physical register at the tail of the queue is used. Consequently, those are the addresses that need to be considered for pre-fetching.
Since the target base registers are not the target of branch, the addresses in their physical registers does not need to be prefetched.
The target return register is being used as a call-return predictor. The physical registers that are marked as the targets of a call are used for the prediction. Consequently, they will have the highest priority among these physical registers. Further, the closer they are to the head, the more likely they are used soon.

Prefetching rules may be generated as the following description. These rules may determine the order to prefetch instructions. The heuristics can be:
to select one of the HD or TL for normal branch target registers;
to prefer pointers marked as written by call for return register;
to select the ones closest to the OoO pointer; or
not to preload the target base registers.

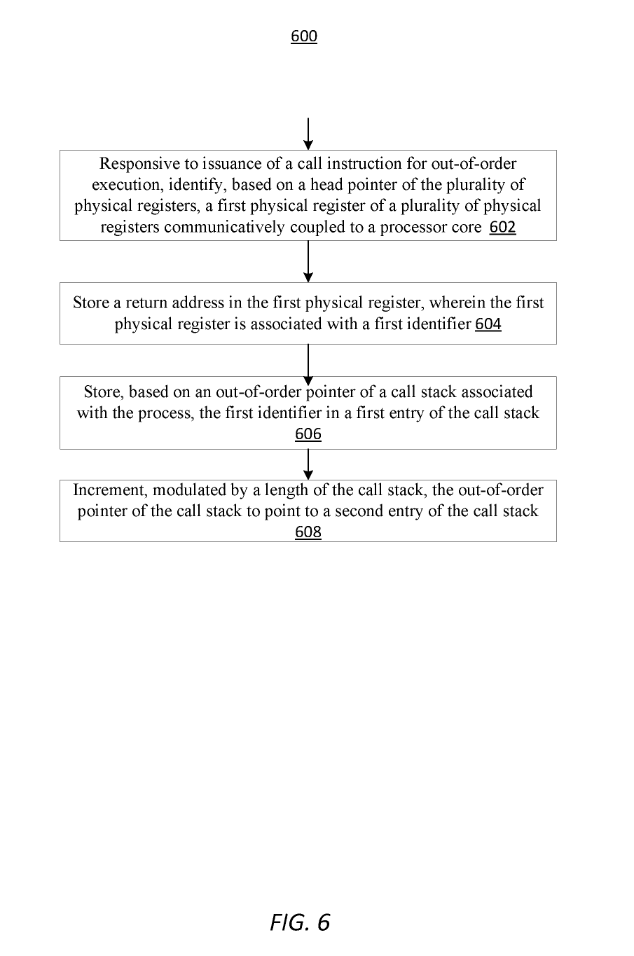

FIG. 6 is a block diagram illustrating a method 600 for speculative executing call/return instructions according to an embodiment of the present disclosure. Referring to FIG. 6, at 602, responsive to issuance of a call instruction for out-of-order execution, a processor core may identify, based on a head pointer of the plurality of physical registers, a first physical register of a plurality of physical registers communicatively coupled to a processor core.

At 604, the processor core may store a return address in the first physical register, wherein the first physical register is associated with a first identifier.

At 606, the processor core may store, based on an out-of-order pointer of a call stack associated with the process, the first identifier in a first entry of the call stack.

At 608, the processor core may increment, modulated by a length of the call stack, the out-of-order pointer of the call stack to point to a second entry of the call stack.

Example 1 of the disclosure is a method including responsive to issuance of a call instruction for out-of-order execution, identifying, based on a head pointer of the plurality of physical registers, a first physical register of a plurality of physical registers communicatively coupled to a processor core, storing a return address in the first physical register, wherein the first physical register is associated with a first identifier, storing, based on an out-of-order pointer of a call stack associated with the process, the first identifier in a first entry of the call stack, and incrementing, modulated by a length of the call stack, the out-of-order pointer of the call stack to point to a second entry of the call stack.

Example 2 of the disclosure is a processor including a plurality of physical registers and a processor core, communicatively coupled to the plurality of physical registers, the processor core to execute a process comprising a plurality of instructions to responsive to issuance of a call instruction for out-of-order execution, identify, based on a head pointer of the plurality of physical registers, a first physical register of the plurality of physical registers, store a return address in the first physical register, wherein the first physical register is associated with a first identifier, store, based on an out-of-order pointer of a call stack associated with the process, the first identifier in a first entry of the call stack, and increment, modulated by a length of the call stack, the out-of-order pointer of the call stack to point to a second entry of the call stack.

While the disclosure has been described with respect to a limited number of embodiments, those skilled in the art will appreciate numerous modifications and variations there from. It is intended that the appended claims cover all such modifications and variations as fall within the true spirit and scope of this disclosure.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ capable of/to,′ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 910 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A processor comprising:
a plurality of physical registers; and
a processor core, communicatively coupled to the plurality of physical registers, the processor core to execute a process comprising a plurality of instructions to:
responsive to issuance of a call instruction for out-of-order execution, identify, based on a head pointer of the plurality of physical registers, a first physical register of the plurality of physical registers;
store a return address in the first physical register, wherein the first physical register is associated with a first identifier;
store, based on an out-of-order pointer of a call stack associated with the process, the first identifier in a first entry of the call stack; and
increment, modulated by a length of the call stack, the out-of-order pointer of the call stack to point to a second entry of the call stack.

2. The processor of claim 1, wherein the processing core is further to:
responsive to issuance of a return instruction corresponding to the call instruction, determine a second entry of the call stack pointed to by the out-of-order pointer;
determine, based on a second identifier stored in the second entry of the call stack, a second physical register of the plurality of physical registers;
determine a predicted return address stored in the second physical register; and
continue instruction execution from the predicted return address.

3. The processor of claim 2, wherein the second physical register is one or same as the first physical register or different than the first physical register, and wherein the second identifier is one of same as the first physical identifier or different than the first physical identifier.

4. The processor of claim 2, wherein the processor core is further to,
responsive to retiring the call instruction, increment, modulated by the length of the call stack, an in-order pointer of the call stack; and
responsive to retiring the return instruction, decrement, modulated by the length of the call stack, the in-order pointer of the call stack.

5. The processor of claim 4, wherein responsive to a rollback of the out-of-order execution, the processor core is to set the out-of-order pointer to point to an entry pointed to by the in-order pointer.

6. The processor of claim 5, wherein the processor core is further to:
responsive to storing the return address in the first physical register, increment, modulated by a length of the ordered list, the head pointer to point to a third physical register of the plurality of physical registers.

7. The processor of claim 1, wherein the plurality of physical registers forms an ordered list, wherein each one of the plurality of physical registers is uniquely associated with an identifier which is an index value of the corresponding physical register in the ordered list.

8. The processor of claim 1, wherein execution of the call instruction is to switch execution of the process from a first branch of instructions to a second branch of instructions, and wherein execution of the return instruction corresponding to the call instruction is to switch from the second branch of instructions to the first branch of instructions.

9. The processor of claim 1, wherein the plurality of physical registers it to provide a pool of renaming registers for an architected register defined in an instruction set architecture (ISA) of the processor.

10. A method comprising:
responsive to issuance of a call instruction for out-of-order execution, identifying, based on a head pointer of the plurality of physical registers, a first physical register of a plurality of physical registers communicatively coupled to a processor core;
storing a return address in the first physical register, wherein the first physical register is associated with a first identifier;
storing, based on an out-of-order pointer of a call stack associated with the process, the first identifier in a first entry of the call stack; and
incrementing, modulated by a length of the call stack, the out-of-order pointer of the call stack to point to a second entry of the call stack.

11. The method of claim 10, further comprising:
responsive to issuance of a return instruction corresponding to the call instruction, determining a second entry of the call stack pointed to by the out-of-order pointer;
determining, based on a second identifier stored in the second entry of the call stack, a second physical register of the plurality of physical registers;
determining a predicted return address stored in the second physical register; and
continuing instruction execution from the predicted return address.

12. The method of claim 11, further comprising:
responsive to retiring the call instruction, incrementing, modulated by the length of the call stack, an in-order pointer of the call stack; and
responsive to retiring the return instruction, decrementing, modulated by the length of the call stack, the in-order pointer of the call stack.

13. The method of claim 12, further comprising:
responsive to storing the return address in the first physical register, incrementing, modulated by a length of the ordered list, the head pointer to point to a third physical register of the plurality of physical registers.

14. The method of claim 10, wherein the plurality of physical registers forms an ordered list, wherein each one of the plurality of physical registers is uniquely associated with an identifier which is an index value of the corresponding physical register in the ordered list.

15. A processor comprising:
an ordered list of physical registers; and
a processor core, communicatively coupled to the plurality of physical registers, the processor core to execute a process comprising a plurality of instructions to:
responsive to issuance of a first call instruction for out-of-order execution, identify, based on a head pointer of the plurality of physical registers, a first physical register of the plurality of physical registers;
store a return address in the first physical register;
set a first indicator associated with the first physical register to a first value indicating that the first physical register is written by a call instruction; and
increment, modulated by a size of the ordered list, the header pointer to point to a second physical register.

16. The processor of claim 15, wherein the processor core is further to:
set an out-of-order pointer to point to the second physical register.

17. The processor of claim 15, wherein the processor core is further to:
responsive to issuance of a second instruction that writes to the second physical register, increment, modulated by a size of the ordered list, the header pointer to point to a third physical register;
set a first indicator associated with the third physical register to a second value indicating that the third physical register is not written by a call instruction; and
maintaining location of the out-of-order pointer to point to the second physical register.

18. The processor of claim 15, wherein the processor core is further to:
responsive to issuance of a return instruction corresponding to the call instruction, determine the return address stored in the second physical register pointed to by the out-of-order pointer;
calculate a predicted return address based on the return address stored in the second physical register;
set a second indicator associated with the second physical register to a first value indicating that the second physical register is used for return address prediction; and
decrement, modulated by the size of the ordered list, the out-of-order pointer until the out-of-order pointer reaches a forth physical register that is associated with the first indicator being set to the first value and the second indicator being set to the second value.

19. The processor of claim 15, wherein the processor core is further to:
responsive to retiring the call instruction, increment, modulated by the size of the ordered list, an in-order pointer of the ordered list of physical pointers until the in-order pointer reaches a fifth physical register that is associated with the first indicator being set to the first value; and
responsive to retiring the return instruction, decrement, modulated by the size of the ordered list, an in-order pointer of the ordered list of physical pointers until the in-order pointer reaches a fifth physical register that is associated with the first indicator being set to the first value.

20. The processor of claim 19, wherein responsive to a rollback, the processor core is further to set the out-of-order pointer to a position pointed to by the in-order pointer.

21. A processor, comprising:
a circular stack implementation of a plurality of physical registers, wherein the circular stack implementation comprises a head pointer, a tail pointer, and a total number (N) of physical registers; and
a processor core, communicatively coupled to the plurality of physical registers, the processor core to execute a process comprising a plurality of instructions to:
responsive to executing a write instruction referencing a first architected register to be renamed, increment, modulated by N, the head pointer to point to a first physical register; and
responsive to executing a read instruction referencing the first architected register, read the first physical register.

22. The processor of claim 21, wherein the tail pointer is initiated to point to a same physical rename register as the head pointer.

23. The processor of claim 21, wherein the processor core is further to:
responsive to freeing the first architected register, increment, modulated by N, the tail pointer.

24. The processor of claim 21, wherein the processor core is further to:
responsive to freeing the first architected register, decrement, modulated by N, the head pointer.

25. The processor of claim 21, wherein responsive to a rollback event, the processor core is further to move the head pointer to point to a same physical register as pointed by the tail pointer.
